(19) United States
(12) Patent Application Publication
(10) Pub. No.: US 2022/0370964 A1
(43) Pub. Date: Nov. 24, 2022

(54) MICROBUBBLE GENERATION MODULE

(71) Applicant: Cheng-Lung JUAN, Kaohsiung (TW)

(72) Inventors: Ching-Yuan JUAN, Kaohsiung (TW); Yi-Hung JUAN, Kaohsiung (TW); Cheng-Lung JUAN, Kaohsiung (TW)

(21) Appl. No.: 17/882,080

(22) Filed: Aug. 5, 2022

Related U.S. Application Data
(63) Continuation of application No. PCT/CN2020/074540, filed on Feb. 7, 2020.

(51) Int. Cl. B01F 23/231; B05B 1/18

(52) U.S. Cl. CPC B01F 23/231263; B05B 1/18

(57) ABSTRACT

A microbubble generation module includes a first net, a second net, and a buffering protection device. The first net is provided with a plurality of first through holes and at least one air intake through hole besides to the plurality of first through holes. The second net is arranged on the first net, and provided with a plurality of second through holes. A body accommodates the first net and the second net. The first through hole and the second through hole communicate with each other to form a fluid communicating channel. The air intake through hole is in communication with the fluid communicating channel. The air intake through hole promotes a generation of microbubbles at communicating parts of the plurality of first through holes and the plurality of second through holes when a liquid passes through the fluid communicating channels.

### CROSS-REFERENCE TO RELATED APPLICATIONS

This application is a continuation of co-pending International Patent Application No. PCT/CN2020/074540, filed on Feb. 7, 2020, which is incorporated by reference herein in its entirety.

### FIELD OF THE INVENTION

The invention relates to a microbubble generation module, in particular to a microbubble generation module for softening a water flow, increasing an air content of the water flow, and improving the fineness of bubbles.

### BACKGROUND OF THE INVENTION

A microbubble generation device is usually mounted in addition to a shower head to generate microbubbles, so that fine bubbles can be generated when a water flow passes through the microbubble generation device. By virtue of this, tiny bubbles may be used to deeply unclog pores of a human body.

Although a conventional microbubble generation device may generate the tiny bubbles, the conventional microbubble generation device is usually mounted at one end, connected with a water inlet pipe, of the shower head. Therefore, when the tiny bubbles are being transferred to a user through the shower head, the tiny bubbles may be broken due to a long path, and the cleaning effect is seriously weakened. Thus, how to solve these problems of the conventional microbubble generation device is an important objective of the industry.

### SUMMARY OF THE INVENTION

An objective of the invention is to solve the problem of insufficient air content of an air-liquid mixture and overlarge bubbles due to a long path when the air-liquid mixture is sprayed by the conventional device.

To achieve the objective, the invention provides a microbubble generation module, comprising a first net and a second net. The first net is provided with a plurality of first through holes, at least one air intake through hole, a first connecting surface and at least one first fixing portion, wherein the at least one air intake through hole is formed beside the plurality of first through holes; and the second net is arranged on the first net and is provided with a plurality of second through holes, a second connecting surface and at least one second fixing portion, wherein the second connecting surface faces the first connecting surface; wherein each of the at least one second fixing portion is correspondingly connected with the at least one first fixing portion from the first connecting surface in an axial direction, and at least one gap is formed between the first connecting surface and the second connecting surface; and wherein the plurality of first through holes and the plurality of second through holes communicating therewith form a plurality of fluid communicating channels, respectively, the at least one air intake through hole communicates with at least one of the plurality of fluid communicating channels via the at least one gap, and the at least one air intake through hole promotes a generation of microbubbles at communicating parts of the plurality of first through holes and the plurality of second through holes when a liquid passes through the fluid communicating channels.

Further, at least one first air intake groove is formed on one of the first connecting surface and the second connecting surface in a recessed manner, and the at least one first air intake groove connects the at least one air intake through hole and the plurality of first through holes.

Further, the at least one first air intake groove further provides a first accommodating chamber attached to the at least one air intake through hole.

Further, the microbubble generation module comprises a body accommodating the first net and the second net, the body comprises a water inlet unit and a water outlet unit assembled on the water inlet unit; the water inlet unit comprises a liquid flow inlet; and the second net is abutted to the liquid flow inlet.

Further, each of the plurality of first through holes is a conical hole gradually narrows toward the first connecting surface; an end of each of the plurality of first through holes further forms a first cylindrical hole segment; each of the plurality of second through holes is a conical hole gradually narrows toward the second connecting surface; and an end of each of the plurality of second through holes further forms a second cylindrical hole segment.

Further, a buffering protection device is arranged around outer peripheries of the first net and the second net.

Further, a third net is arranged between the first net and the second net, wherein the third net comprises a plurality of third through holes and at least one connecting hole; the plurality of third through holes correspondingly communicate with the plurality of second through holes and the plurality of first through holes; and the at least one connecting hole correspondingly communicate with the at least one air intake through hole.

Further, a third connecting surface is opposite to the second connecting surface; the third connecting surface of the third net is recessed; and at least one second air intake groove connects the at least one connecting hole and the plurality of third through holes.

Further, the at least one second air intake groove further provides a second accommodating chamber attached to a section of perimeter of the at least one connecting hole.

Further, at least one gapping unit is arranged between the first connecting surface of the first net and the second connecting surface of the second net.

Therefore, the invention has the following advantages compared with the conventional microbubble generation device.

1. The microbubble generation module of one embodiment of the invention is directly arranged inside the shower head, so that a liquid with microbubbles is provided for a shower of a user immediately after being generated from the shower head, avoiding the microbubbles to break due to a long path.

2. The microbubble generation module of another embodiment of the invention is directly mounted at a water outlet pipe of an aerator for mixing air and liquid. The liquid mixed with microbubbles is guided to a sewage or a culture pond of a farmer to increase aeration.

3. The air intake through hole is formed in the first net of the water outlet unit. After the first net and the second net are combined, the gap or the first air intake groove is provided. External air is sucked into the gap or the first air intake groove by the air intake through hole; so that the external air is mixed with liquid at the communicating parts of the plurality of first through holes of the first net and the plurality of second through holes of the second net to increase an air-liquid mixing ratio. Also, the liquid mixed with the microbubbles is directly sprayed onto the user, and provided benefits.

### BRIEF DESCRIPTION OF THE DRAWINGS

FIG. 1 is a exploded perspective view of a first embodiment of the invention.

FIG. 2A is a schematic diagram of the first embodiment of the invention.

FIG. 2B is a cross-section diagram along line 2B-2B in FIG. 2A.

FIG. 2C is a cross-section operation diagram along line 2C-2C in FIG. 2A.

FIGS. 3, 4, 5, 6 and 7 are schematic diagrams of other embodiments along line 2C-2C in FIG. 2A.

FIG. 8 is an operation diagram of an enlarged partial view section of a second embodiment of the invention.

FIGS. 9, 10, 11, 12 and 13 are schematic diagrams of other embodiments based on the second embodiment of the invention.

FIG. 14A is a partial section schematic diagram of a first net according to the first embodiment of the invention.

FIG. 14B is an enlarged partial view of an encircled portion 14B in FIG. 14A.

FIG. 15A is a partial section schematic diagram of another first net according to the first embodiment of the invention.

FIG. 15B is an enlarged partial view of an encircled portion 15B in FIG. 15A.

FIG. 16A is a partial section schematic diagram of another first net according to the first embodiment of the invention.

FIG. 16B is an enlarged partial view of an encircled portion 16B in FIG. 16A.

FIG. 17A is a partial section schematic diagram of another first net according to the first embodiment of the invention.

FIG. 17B is an enlarged partial view of an encircled portion 17B in FIG. 17A.

FIG. 18A is a partial section schematic diagram of another first net according to the first embodiment of the invention.

FIG. 18B is an enlarged partial view of an encircled portion 18B in FIG. 18A.

FIG. 19A is a partial section schematic diagram of another first net according to the first embodiment of the invention.

FIG. 19B is an enlarged partial view of an encircled portion 19B in FIG. 19A.

FIG. 20A is a partial section schematic diagram of another first net according to the first embodiment of the invention.

FIG. 20B is an enlarged partial view of an encircled portion 20B in FIG. 20A.

FIGS. 21, 22 and 23 are enlarged partial views of other embodiments of an encircled portion 20B in FIG. 20A.

FIG. 24A is a schematic diagram of a third embodiment of the invention.

FIG. 24B is an enlarged partial view of a portion bounded by a rectangle 24B in FIG. 24A.

FIG. 24C is an enlarged partial view of cross-section along line 24C-24C in FIG. 24A.

FIG. 25 is a exploded perspective view of a fourth embodiment of the invention.

FIG. 26 is a perspective view of the fourth embodiment of the invention.

FIG. 27 is a cross-section diagram of the fourth embodiment of the invention.

FIG. 28 is a exploded perspective view of a fifth embodiment of the invention.

FIG. 29 is a cross-section diagram of the fifth embodiment of the invention.

### DETAILED DESCRIPTION OF THE PREFERRED EMBODIMENTS

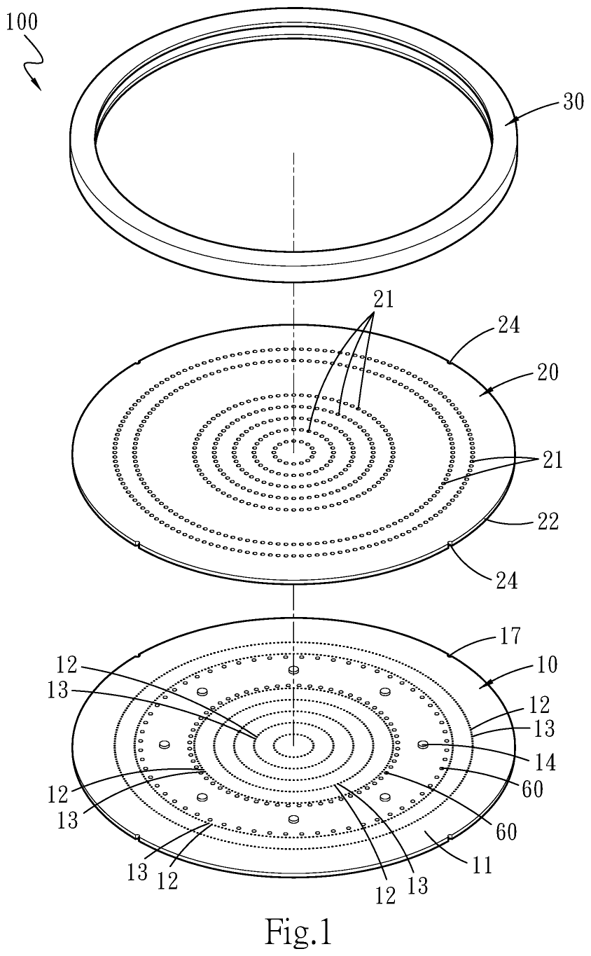

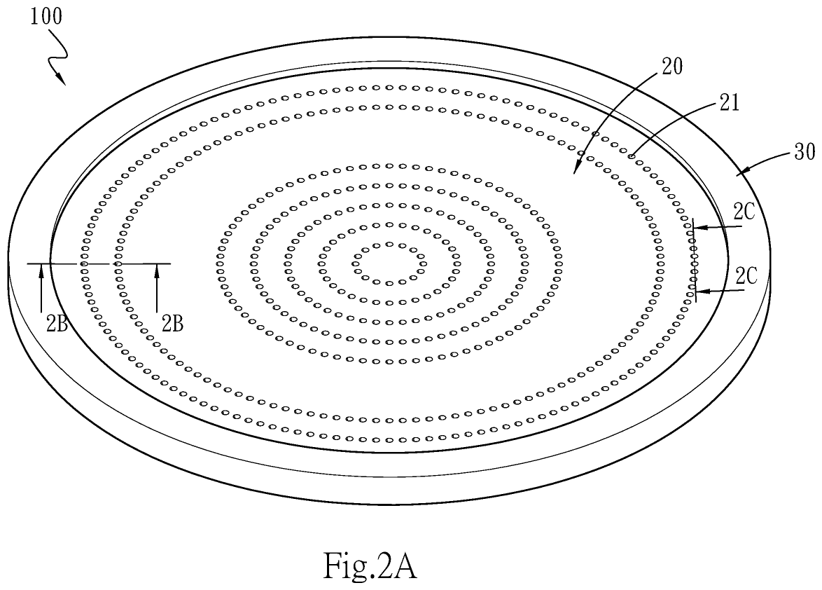

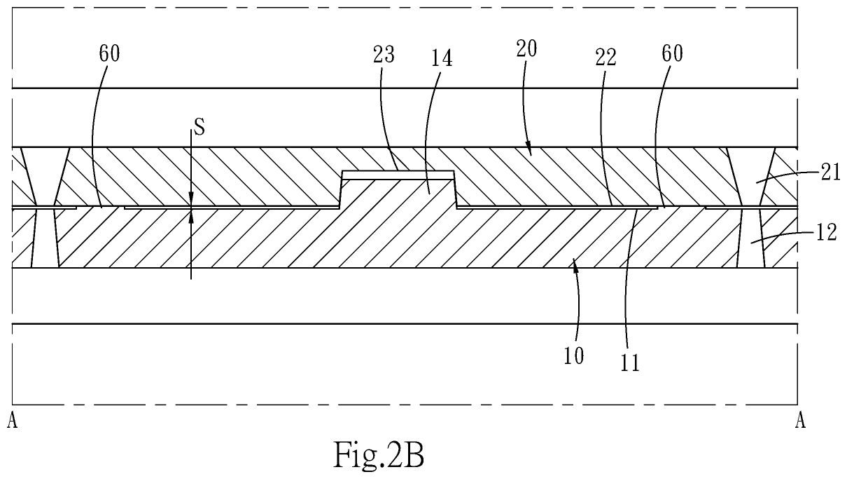

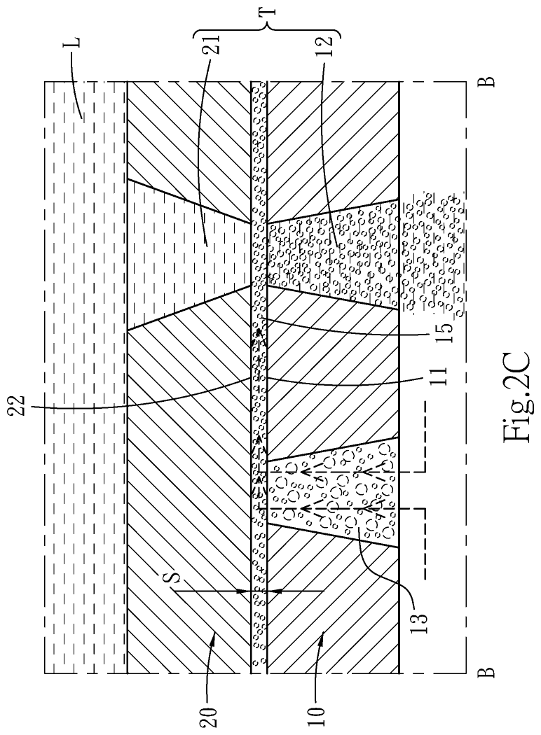

A microbubble generation module 100 of the invention is used for aeration equipments in the industries, such as sewage treatment industry and aquaculture industries, and is used for household equipments, such as a shower head and a faucet. Referring to FIGS. 1, 2A, 2B and 2C, the microbubble generation module 100 according to a first embodiment of the invention comprises a first net 10, a second net 20 and a buffering protection device 30.

The first net 10 is provided with a first connecting surface 11, a plurality of first through holes 12, a plurality of air intake through holes 13 and a plurality of first fixing portions 14, wherein the plurality of air intake through holes 13 are formed beside the corresponding plurality of first through holes 12 The plurality of first through holes 12 and the plurality of air intake through holes 13 penetrate through the first connecting surface 11. In the first embodiment of the invention, the plurality of first through holes 12 and the plurality of air intake through holes 13 are conical holes and are staggered. In one embodiment, the plurality of first through holes 12 and the plurality of air intake through holes 13 are arranged into a circle as shown in FIG. 1, whereas a plurality of first positioning holes 17 are formed on the perimeter of the first net 10.

The second net 20 is arranged on the first net 10 and is provided with a plurality of second through holes 21, a second connecting surface 22 and a plurality of second fixing portions 23, wherein the second connecting surface 22 faces the first connecting surface 11; and wherein the plurality of second through holes 21 penetrate through the second connecting surface 22. In this embodiment, the plurality of second through holes 21 are conical holes and are approximately arranged into a circle as the plurality of first through holes 12; whereas a plurality of second positioning holes 24 are further formed in the second net 20, corresponding to the first positioning holes 17 of the first net 10.

The buffering protection device 30 is arranged around outer peripheries of the first net 10 and the second net 20.

Referring to FIG. 2B, each of the plurality of second fixing portion 23 is correspondingly connected with the plurality of first fixing portions 14 from the first connecting surface 11 in an axial direction. Thus, the plurality of first fixing portions 14 are not fully sealed with the plurality of second fixing portions 23, and a gap S is formed between the first connecting surface 11 and the second connecting surface 22. In the first embodiment, the plurality of first fixing portions 14 protrude from the first net 10 in the axial direction. The plurality of first fixing portions 14 abut against the plurality of second fixing portions 23 in the axial direction, which limited a position of the plurality of first fixing portions 14 to the second net 20. The plurality of second fixing portions 23 are recessed correspondingly to the plurality of first fixing portions 14 in the axial direction. The plurality of first fixing portions 14 and the plurality of second fixing portions 23 are fixed by using laser spot welding, rivets or forming screw holes into the plurality of first fixing portions 14 and the plurality of second fixing portions 23 for screws and nuts to penetrate through. In one embodiment, the plurality of first fixing portions 14 and the plurality of second fixing portions 23 are formed when feeding plastics to injection molding while forming the first net 10 and the second net 20. In the first embodiment of the invention, each of the plurality of first fixing portions 14 forms a convex point to be connected and limited with a concave point formed by each of the plurality of second fixing portions 23. The buffering protection device 30 presses and covers outer peripheral sides of the first net 10 and the second net 20 in a sleeving manner. The plurality of first fixing portions 14 at the first connecting surface 11 connect and fit with the plurality of second fixing portions 23 at the second connecting surface 22, while providing the gap S between the first connecting surface 11 and the second connecting surface 22. In the first embodiment of the invention, a plurality of gapping units 60 are further arranged between the first connecting surface 11 and the second connecting surface 22. The plurality of gapping units 60 are besides the plurality of first through holes 12 and the plurality of air intake through holes 13 that are circularly arranged. The plurality of gapping units 60 further maintains a distance of the gap S that formed between the first connecting surface 11 of the first net 10 and the second connecting surface 22 of the second net 20.

Referring to FIG. 2C, one of the plurality of first through holes 12 communicates one of the corresponding plurality of second through holes 21 and a fluid communicating channel T is formed. In the first embodiment of the invention, the plurality of first through holes 12 gradually narrow toward the first connecting surface 11, and the plurality of second through holes 21 gradually narrow toward the second connecting surface 22. By aligning the plurality of first positioning holes 17 with the plurality of second positioning holes 24, each of the plurality of first through holes 12 is aligned with the corresponding plurality of second through hole 21 to form the fluid communicating channel T, when the first net 10 and the second net 20 are assembled. The amount of the plurality of first through holes 12 that do not correspond to the plurality of second through holes 21 is reduced. Each of the plurality of air intake through holes 13 communicates with at least one fluid communicating channels T via the gap S; and the plurality of air intake through holes 13 promote a generation of microbubbles at communicating parts of the plurality of first through holes 12 and the plurality of second through holes 21 when a liquid L passes through the fluid communicating channel T.

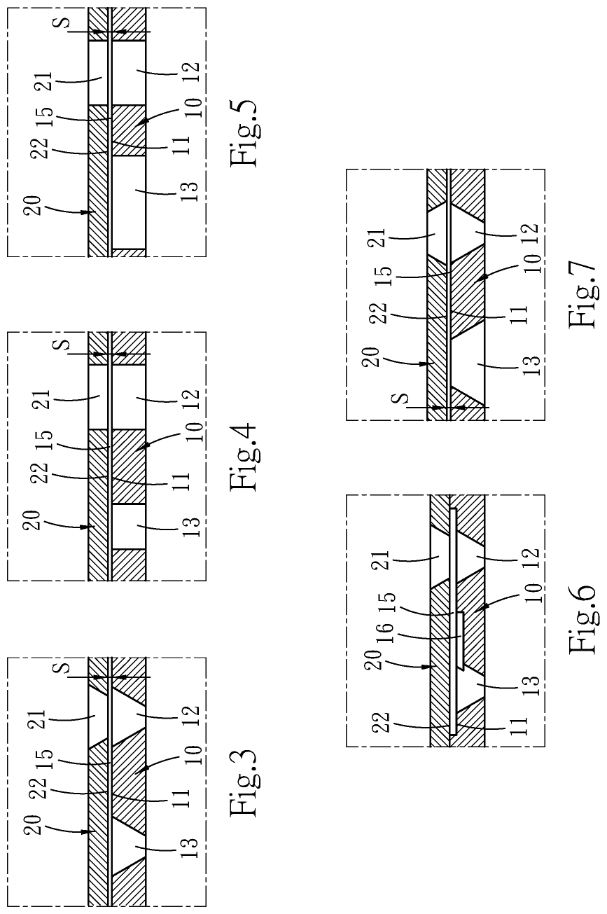

Referring to FIGS. 3, 4, 5, 6 and 7, descriptions of the main structure same as the first embodiment are omitted here. A main difference is that the plurality of first through holes 12 of the first net 10 and the plurality of second through holes 21 of the second net 20 are in different shapes. According to the cross-section diagrams, the plurality of air intake through holes 13, the plurality of first through holes 12 and the plurality of second through holes 21 are approximately in conical shape as shown in FIG. 3, FIG. 6 and FIG. 7 or in cylindrical shape as shown in FIG. 4 and FIG. 5. As shown in FIG. 7, the plurality of second through holes 21 gradually expand toward the second connecting surface 22, and the plurality of first through holes 12 gradually expand toward the first connecting surface 11, and the plurality of air intake through holes 13 gradually narrow toward the first connecting surface 11. An aperture width of each of the plurality of second through holes 21 on another plane opposite to the second connecting surface 22 is larger than an aperture width of each of the plurality of first through holes 12 on another plane opposite to the first connecting surface 11. Referring to FIG. 6, the gap S is a first air intake groove 15 which is formed on the first connecting surface 11 or the second connecting surface 22 in a recessed manner and connected with the plurality of air intake through holes 13 and the plurality of first through holes 12. The first air intake groove 15 further provides a first accommodating chamber 16 attached to the plurality of air intake through holes 13. The main function and a mode of generating a negative pressure in this embodiment are as described in the first embodiment of the invention. In addition, referring to FIG. 4 and FIG. 5, an aperture width of each of the plurality of first through holes 12 is different from an aperture width of each of the plurality of second through holes 21. In general, the aperture width of each of the plurality of first through holes 12 is not larger than the aperture width of each of the plurality of second through holes 21, and a difference of aperture widths is about between 0.01 μm and 0.02 μm. When the liquid L from the plurality of second through holes 21 is mixed with air from the plurality of air intake through holes 13 at a joint position of the first connecting surface 11 and the second connecting surface 22, the effects of mixing and emulsification are improved.

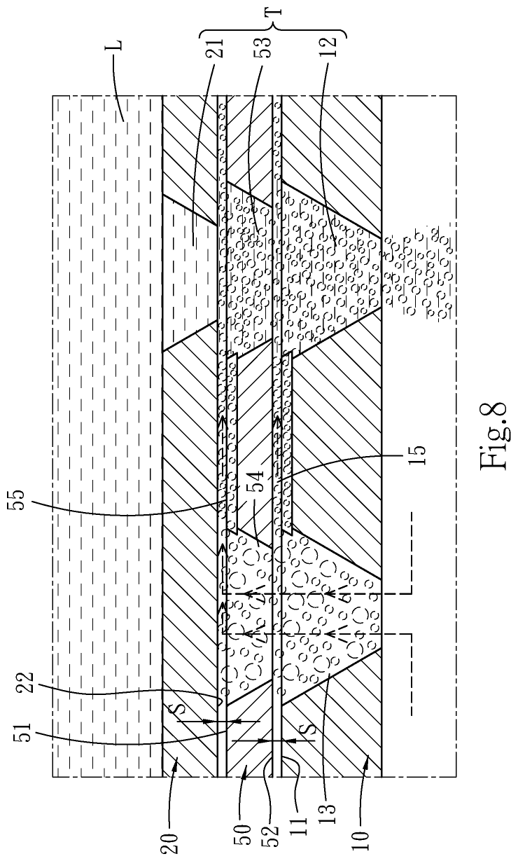

Referring to FIG. 8, it shows a second embodiment of the invention, in which a third net 50 is added between the first net 10 and the second net 20. The third net 50 comprises a third connecting surface 51 facing the second connecting surface 22, a fourth connecting surface 52 facing the first connecting surface 11, a plurality of third through holes 53 and a plurality of connecting holes 54. The plurality of third through holes 53 communicate with the plurality of second through holes 21 and the plurality of first through holes 12 to form the fluid communicating channel T. The plurality of connecting holes 54 communicate with the plurality of air intake through holes 13. The gap S is formed between the first connecting surface 11 and the fourth connecting surface 52. A plurality of first air intake grooves 15 are formed on the first connecting surface 11 in a recessed manner, and the plurality of first air intake grooves 15 are connected and provided between the plurality of air intake through holes 13 of the first net 10 and the corresponding plurality of first through holes 12. The gap S is formed between the second connecting surface 22 and the third connecting surface 51. A plurality of second air intake grooves 55 are formed on the third connecting surface 51 in a recessed manner, and the plurality of second air intake grooves 55 are connected and provided between the plurality of connecting holes 54 of the third net 50 and the corresponding plurality of third through holes 53.

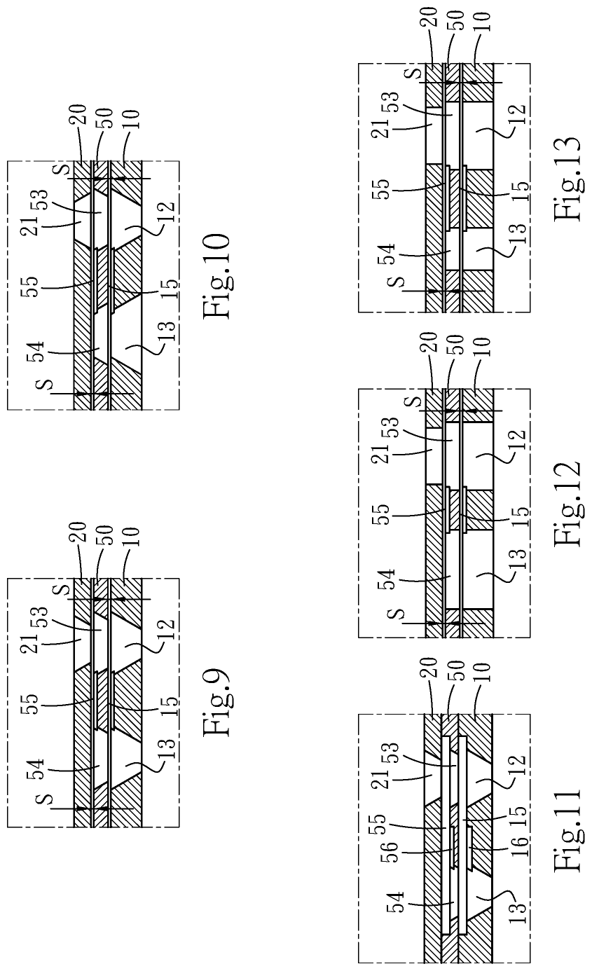

Referring to FIGS. 9, 10, 11, 12 and 13, descriptions of the main structure same as the first embodiment are omitted here. A main difference is that the plurality of first through holes 12 of the first net 10, the plurality of air intake through holes 13, the plurality of second through holes 21 of the second net 20, the plurality of third through holes 53 of the third net 50 and the plurality of connecting holes 54 are in different shapes. The gap S is formed between the first connecting surface 11 and the fourth connecting surface 52. The gap S is formed between the second connecting surface 22 and the third connecting surface 51. Meanwhile, the first air intake groove 15 is formed on the first connecting surface 11 in a recessed manner between the plurality of first through holes 12 and the plurality of air intake through holes 13. The second air intake groove 55 is formed on the third connecting surface 51 in a recessed manner between the plurality of third through hole 53 and the plurality of connecting hole 54. Referring to FIG. 11, the first air intake groove 15 and the second air intake groove 55 are the gaps S. The first air intake groove 15 further provides the first accommodating chamber 16 attached to each of the plurality of air intake through holes 13. The second air intake groove 55 further provides a second accommodating chamber 56 attached to each of the plurality of connecting hole 54. The first accommodating chamber 16 and the second accommodating chamber 56 increase air-liquid mixing ratio and promote emulsification. According to the cross-section diagrams, the plurality of air intake through holes 13, the plurality of first through holes 12, the plurality of second through holes 21 the plurality of third through holes 53, and the plurality of connecting holes 54 are approximately in conical shape as shown in FIG. 9, FIG. 10 and FIG. 11 or in cylindrical shape as shown in FIG. 12 and FIG. 13. As shown in FIG. 10, the plurality of second through holes 21 gradually expand toward the second connecting surface 22; the plurality of first through holes 12 gradually expand toward the first connecting surface 11; the plurality of third through holes 53 gradually expand from the fourth connecting surface 52 toward the third connecting surface 51; the plurality of connecting holes 54 gradually narrow toward the third connecting surface 51; and the plurality of air intake through holes 13 gradually narrow toward the first connecting surface 11. Further, an aperture width of each of the plurality of second through holes 21 on another plane opposite to the second connecting surface 22 is larger than an aperture width of each of the plurality of first through holes 12 on another plane opposite to the first connecting surface 11. The main function and a mode of generating a negative pressure of the microbubble generation module are as described in the first embodiment of the invention.

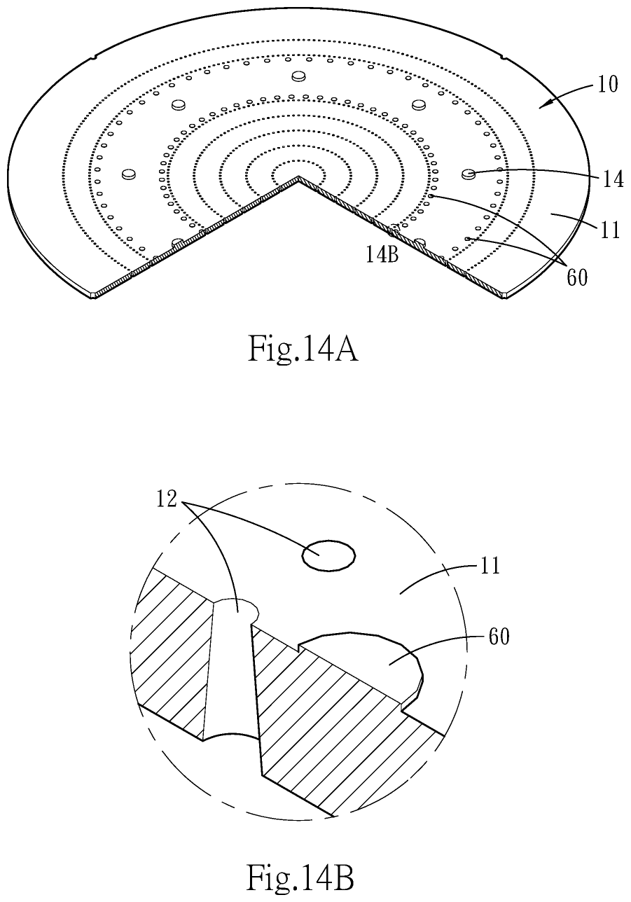

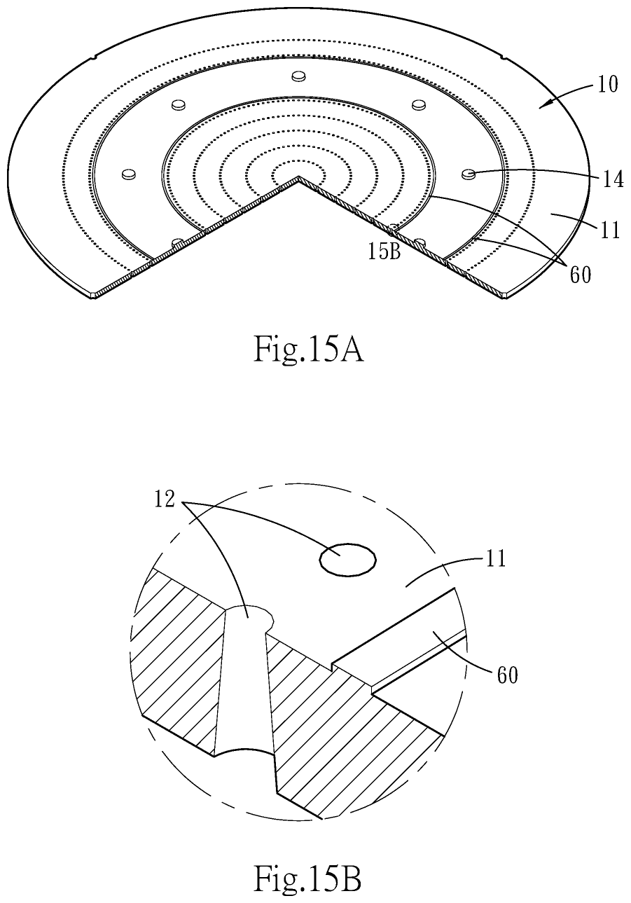

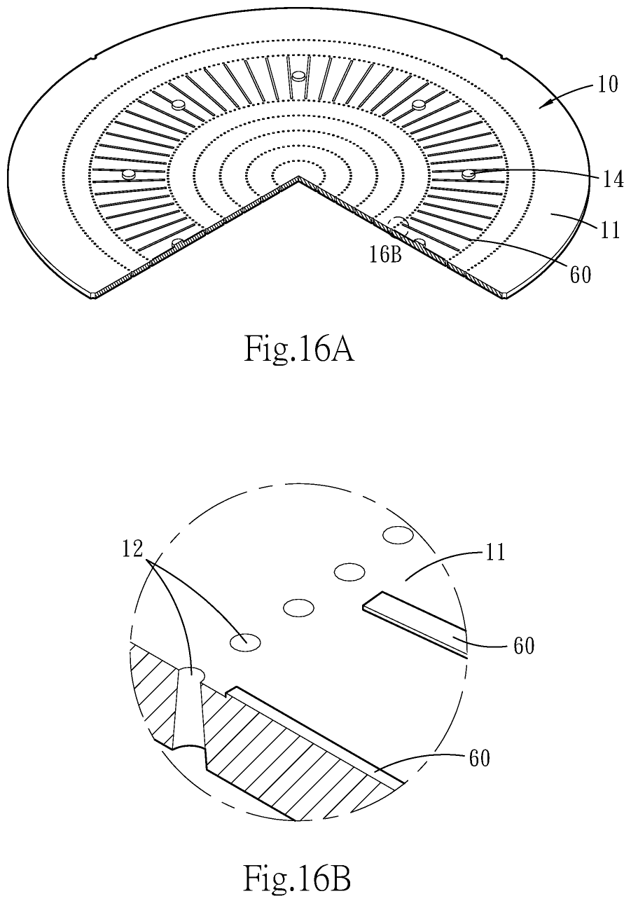

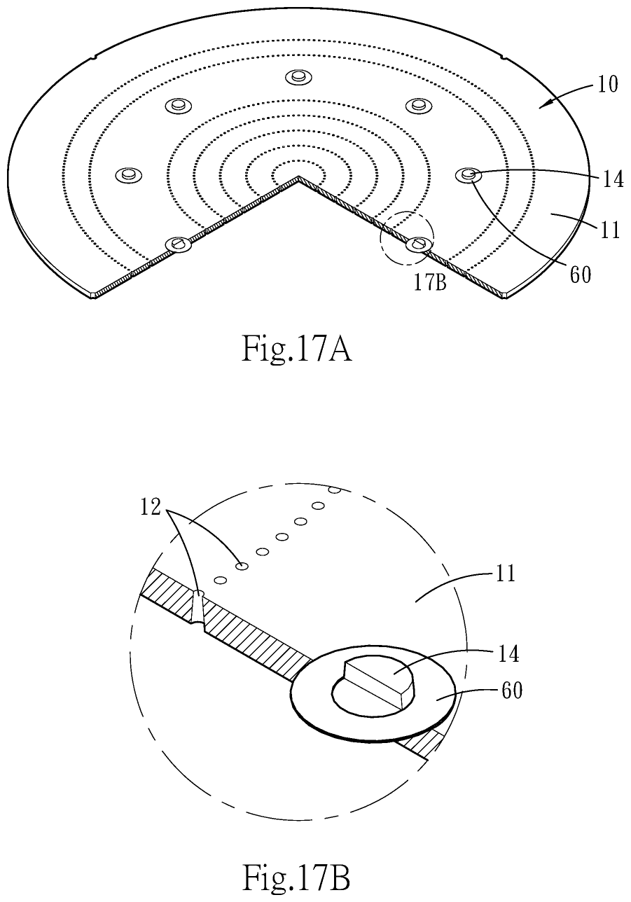

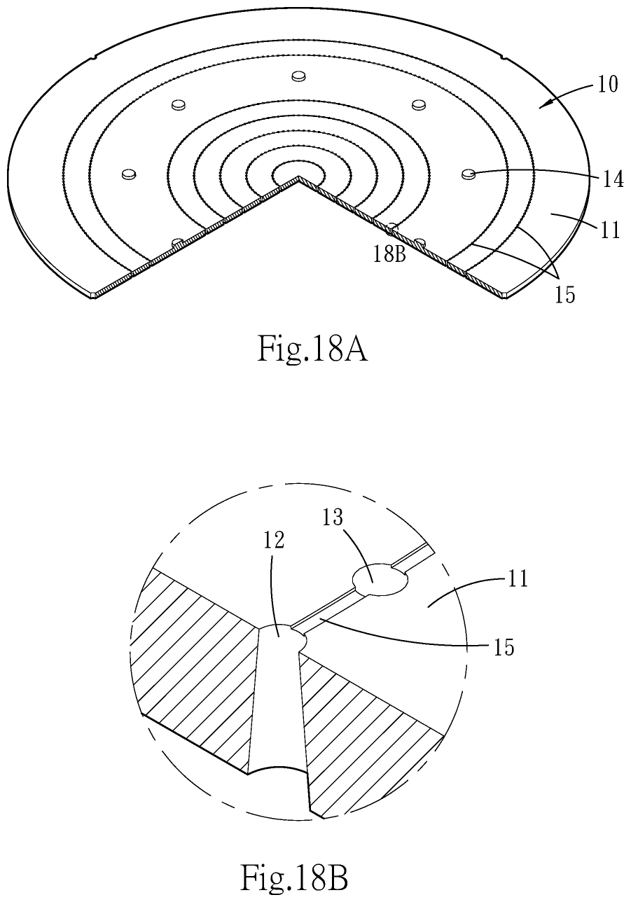

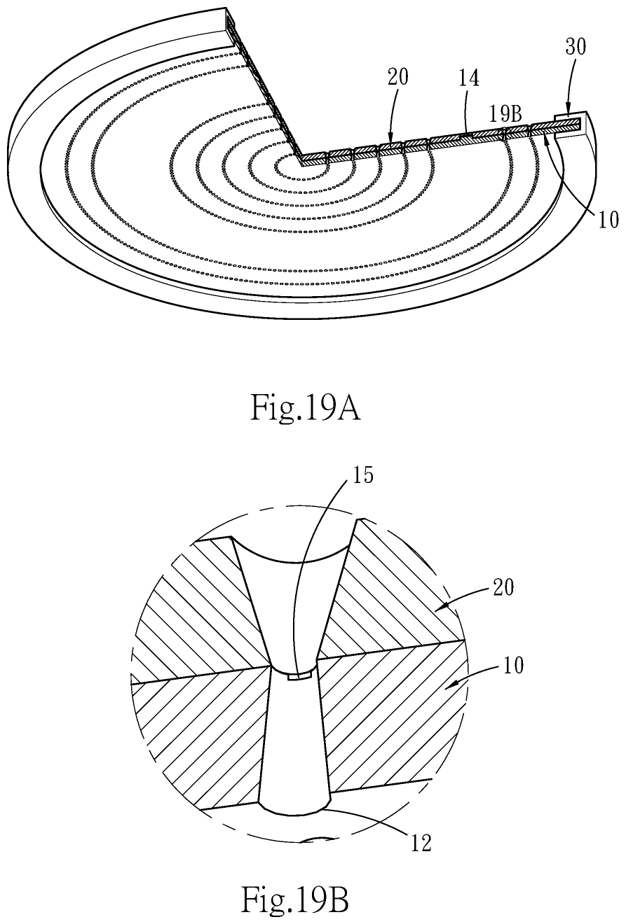

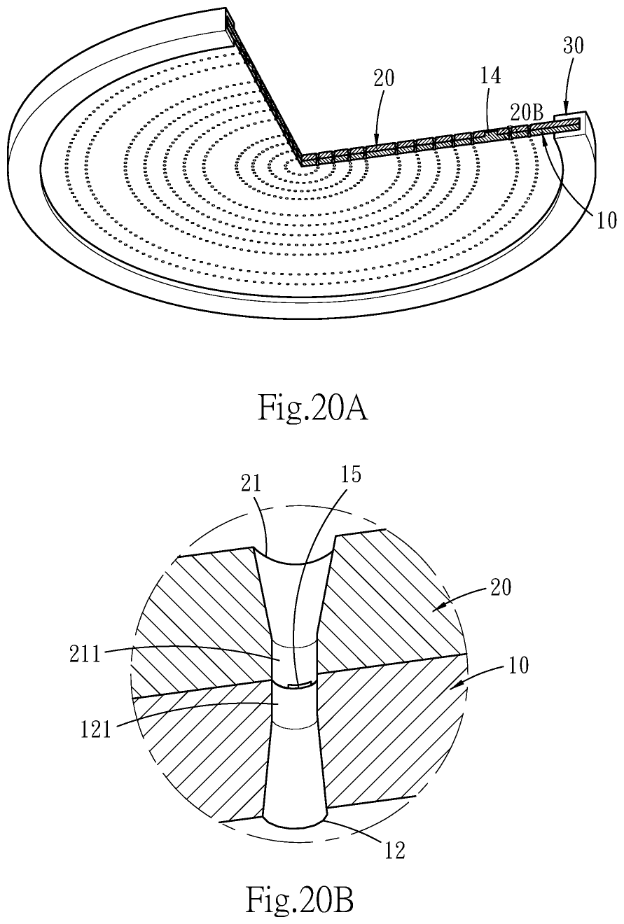

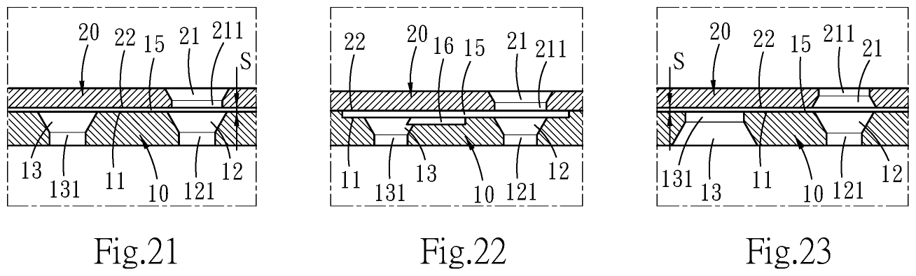

Referring to FIG. 14A and FIG. 14B, the plurality of gapping units 60 are approximately formed in a cylindrical shape protruding from the first connecting surface 11 of the first net 10 in the first embodiment of the invention. Referring to FIG. 15A and FIG. 15B, the plurality of gapping units 60 are approximately formed in a ring shape protruding from the first connecting surface 11 in an axial direction of the first net 10. Referring to FIG. 16A and FIG. 16B, the plurality of gapping units 60 are approximately formed in a strip shape protruding from the first connecting surface 11 in a radial direction of the first net 10. Referring to FIG. 17A and FIG. 17B, for the first net 10, the plurality of first fixing portions 14 protrude from the first connecting surface 11 in a radial direction, and the plurality of gapping units 60 surround the plurality of first fixing portions 14. Referring to FIG. 18A and FIG. 18B, the first air intake grooves 15 are formed on the first connecting surface 11 in a recessed manner, are approximately formed in a circular shape, and are connected with the plurality of first through holes 12 and the plurality of air intake through holes 13. Referring to FIG. 19A and FIG. 19B, the first air intake groove 15 between the first connecting surface 11 and the second connecting surface 22 is the gap S. Therefore, the gap S, the gap S and the first air intake groove 15, or the gap S as the first air intake groove 15 is formed between the first connecting surface 11 and the second connecting surface 22. Referring to FIGS. 20A, 20B, 21, 22 and 23, the plurality of first through holes 12, the plurality of air intake through holes 13 and the plurality of second through holes 21 are approximately in a conical shape. A first cylindrical hole segment 121, an air intake cylindrical hole segment 131 and a second cylindrical hole segment 211 are respectively formed at corresponding one end of each of the plurality of first through holes 12, the plurality of air intake through holes 13 and the plurality of second through holes 21. The first net 10 provided with the first cylindrical hole segments 121, the air intake cylindrical hole segments 131 and the second cylindrical hole segments 211 is demoulded conveniently during the manufacturing process after feeding the plastics to injection molding. Referring to the embodiment in FIG. 20B, the first cylindrical hole segments 121 and the second cylindrical hole segments 211 are abutted to the first connecting surface 11 and the second connecting surface 22. After a liquid L mixes with air and flows via the plurality of first through holes 12 provided with the first cylindrical hole segments 121, an outlet state of the liquid L entering the plurality of second through holes 21 is better.

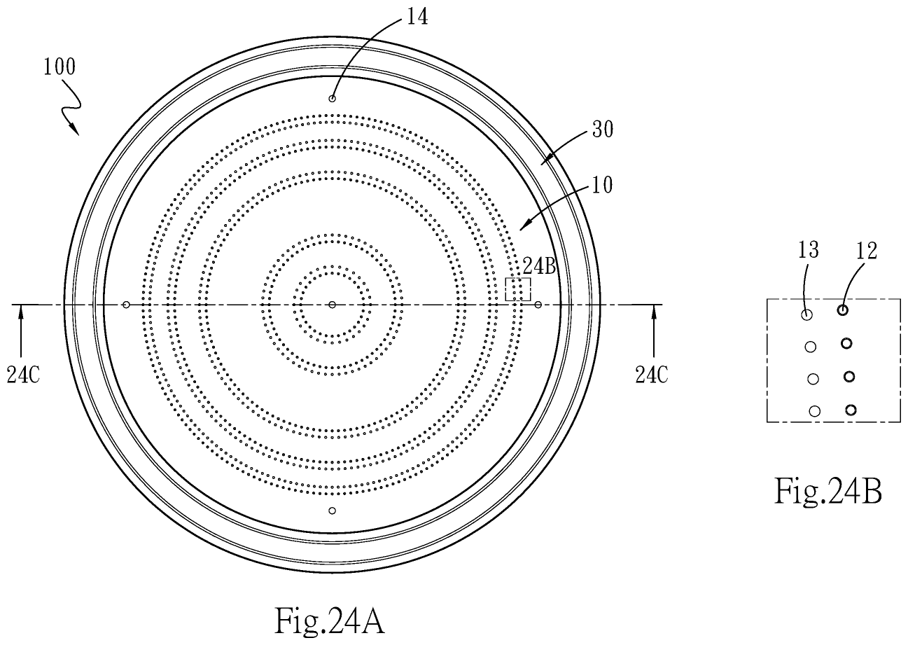

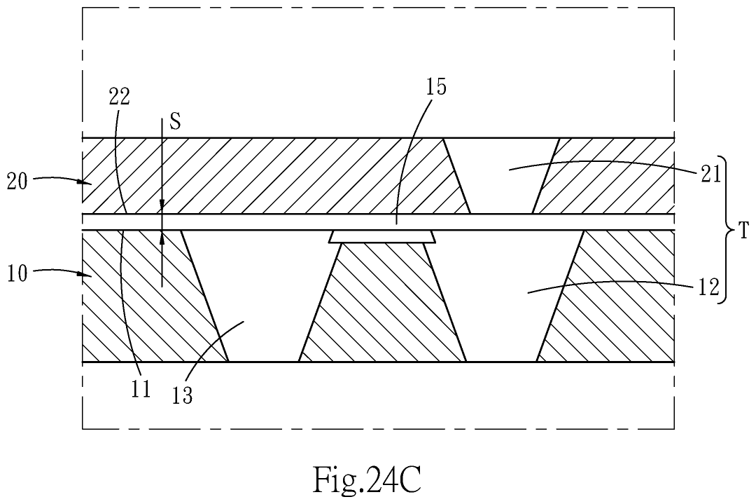

Referring to FIGS. 24A, 24B and 24C, which show a third embodiment of the invention, the main features as described in the first embodiment is omitted here. The third embodiment has a main difference from the first embodiment that the plurality of first through holes 12 and the plurality of air intake through holes 13 are arranged in different radii of the first net 10. The external air is sucked and mixed with the liquid between the plurality of first through holes 12 and the plurality of second through holes 21 via the plurality of air intake through holes 13 to generate microbubbles.

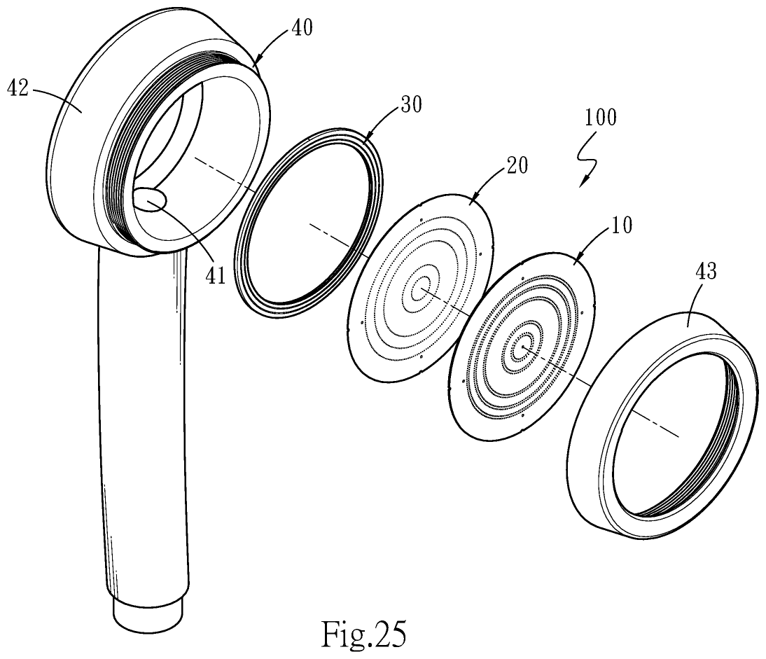

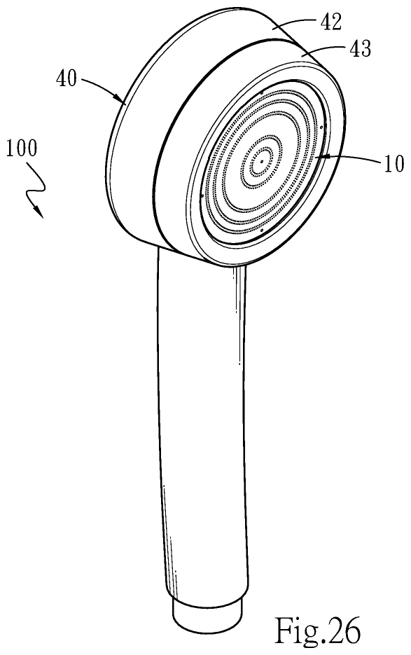

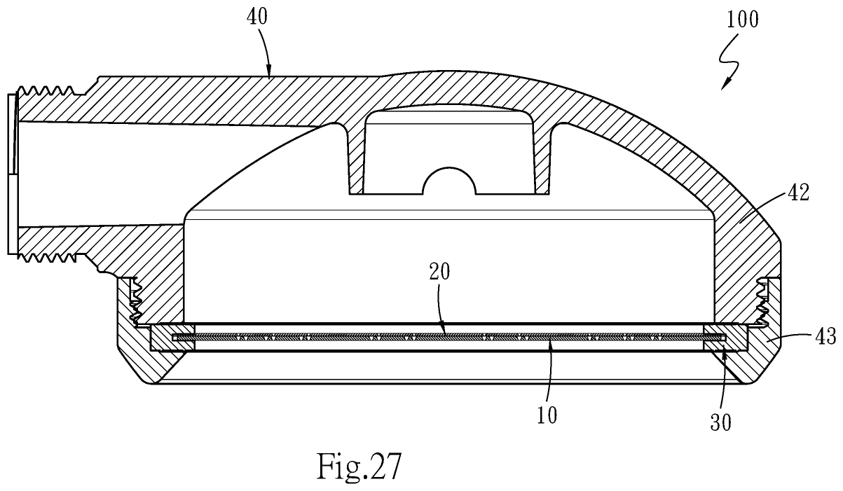

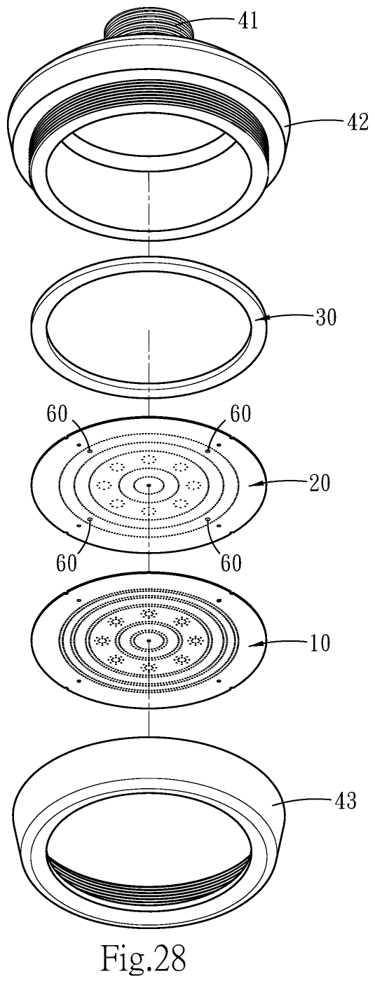

Referring to FIGS. 25, 26 and 27, which show a fourth embodiment of the invention. Main structure as described in the first embodiment is omitted here. The microbubble generation module 100 further comprises a body 40. The body 40 comprises a liquid flow inlet 41, and the body 40 accommodates the first net 10, the second net 20 and the buffering protection device 30, wherein the body 40 further comprises a water inlet unit 42 provided with the liquid flow inlet 41 and a water outlet unit 43 locked on the water inlet unit 42. In the fourth embodiment of the invention, the body 40 is a handheld shower head.

Referring to FIG. 2C, FIG. 8 and FIG. 24C, when the liquid L flows from the liquid flow inlet 41 and passes through the fluid communicating channel T, Venturi effect is performed. The fluid communicating channel T is formed by the plurality of second through holes 21 and the plurality of first through holes 12. In detail, pressure at the communicating parts of the plurality of first through holes 12 and the plurality of corresponding second through hole 21 decreases due to an unbalanced water pressure occurred at the communicating part when a water flow passes through the communicating part of the fluid communicating channel T. The gap S between the first connecting surface 11 of the first net 10 and the second connecting surface 22 of the second net 20 is formed by assembly of the plurality of second fixing portions 23 and the protruded plurality of first fixing portions 14 in the axial direction or formed by providing the plurality of gapping units 60. Therefore, the external air is sucked from the plurality of air intake through holes 13 into the communicating part of the nearest fluid communicating channel T along a shortest path, when the pressure decreased due to an unbalanced water pressure at the communicating part. The shortest path passes through the first air intake groove 15 or the gap S between the first connecting surface 11 and the second connecting surface 22. An air flowing path is shown as a dotted line in the drawings. The sucked air is mixed with the liquid L at the communicating part of the fluid communicating channel T to generate the liquid L with microbubbles; and then the liquid L is sprayed out from one end of the water outlet unit 43 through the plurality of first through holes 12 of the first net 10.

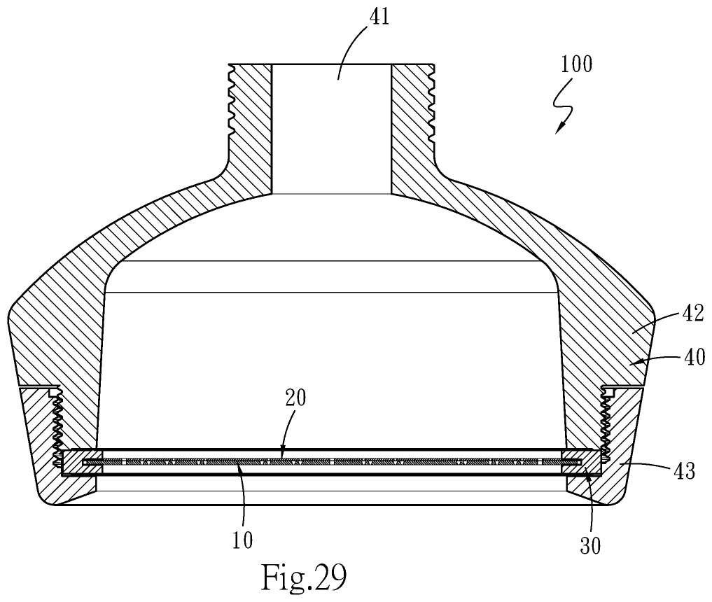

Referring to FIG. 28 and FIG. 29, the body 40 of a fifth embodiment of the invention is mainly in a funnel shape spray tap. The plurality of gapping units 60 are provided between the first connecting surface 11 of the first net 10 and the second connecting surface 22 of the second net 20. The plurality of gapping units 60 maintain a distance of the gap S between the first net 10 and the second net 20. Other structures described in the first embodiment are omitted here.

To sum up, in the invention, the first net 10 and the second net 20 are mounted in the body 40 of the shower head or the spray tap, and the first connecting surface 11 of the first net 10 faces the second connecting surface 22 of the second net 20. The plurality of first through holes 12 and the plurality of second through holes 21 provide the fluid communicating channel T, which the liquid L passes through. First, the liquid L flows from the liquid flow inlet 41 of the water inlet unit 42 of the body 40. The liquid L generate a negative pressure the fluid communicating channel T at the communicating part of the first connecting surface 11 and the second connecting surface 22, so that external air is sucked from the plurality of air intake through holes 13 of the first net 10. Immediately after external air is mixed with the liquid L at the communicating part, the mixture is provided for shower of the body of the user. In one embodiment, a first air intake groove 15 is formed between the plurality of air intake through holes 13 and the plurality of first through holes 12. Extra adjustments of distance between the first net 10 and the second net 20 after assembly thereof is eliminated, and stable quality of production of the microbubble generation module 100 is achieved.

What is claimed is:

1. A microbubble generation module, comprising:
a first net, provided with a first connecting surface, a plurality of first through holes, at least one air intake through hole and at least one first fixing portion, wherein the at least one air intake through hole is formed beside the plurality of first through holes, the plurality of first through holes and the at least one air intake through hole penetrate through the first connecting surface in an axial direction of the first net, and each of the plurality of first through holes is disposed alongside the at least one air intake through holes; and
a second net, arranged on the first net and provided with a plurality of second through holes, a second connecting surface and at least one second fixing portion, wherein the second connecting surface faces the first connecting surface;
wherein each of the at least one second fixing portion is correspondingly connected with the at least one first fixing portion from the first connecting surface in an axial direction; and at least one gap is formed between the first connecting surface and the second connecting surface; and
wherein the plurality of first through holes and the plurality of second through holes communicating therewith form a plurality of fluid communicating channels, respectively, the at least one air intake through hole communicates with at least one of the plurality of fluid communicating channels via the at least one gap, and the at least one air intake through hole promotes a generation of microbubbles at communicating parts of the plurality of first through holes and the plurality of second through holes when a liquid passes through the fluid communicating channels.

2. The microbubble generation module according to claim 1, wherein at least one first air intake groove is formed on one of the first connecting surface and the second connecting surface in a recessed manner, and the at least one first air intake groove connects the at least one air intake through hole and the plurality of first through holes.

3. The microbubble generation module according to claim 2, wherein the at least one first air intake groove further provides a first accommodating chamber attached to the at least one air intake through hole.

4. The microbubble generation module according to claim 1, wherein the microbubble generation module comprises a body accommodating the first net and the second net, the body comprises a water inlet unit and a water outlet unit assembled on the water inlet unit; the water inlet unit comprises a liquid flow inlet; and the second net is abutted to the liquid flow inlet.

5. The microbubble generation module according to claim 2, wherein each of the plurality of first through holes is a conical hole gradually narrows toward the first connecting surface; an end of each of the plurality of first through holes further forms a first cylindrical hole segment; each of the plurality of second through holes is a conical hole gradually narrows toward the second connecting surface; and an end of each of the plurality of second through holes further forms a second cylindrical hole segment.

6. The microbubble generation module according to claim 1, wherein a buffering protection device is arranged around outer peripheries of the first net and the second net.

7. The microbubble generation module according to claim 1, wherein a third net is arranged between the first net and the second net, wherein the third net comprises a plurality of third through holes and at least one connecting hole; the plurality of third through holes correspondingly communicate with the plurality of second through holes and the plurality of first through holes; and the at least one connecting hole correspondingly communicate with the at least one air intake through hole.

8. The microbubble generation module according to claim 7, wherein a third connecting surface is opposite to the second connecting surface; the third connecting surface of the third net is recessed; and at least one second air intake groove connects the at least one connecting hole and the plurality of third through holes.

9. The microbubble generation module according to claim 8, wherein the at least one second air intake groove further provides a second accommodating chamber attached to a section of perimeter of the at least one connecting hole.

10. The microbubble generation module according to claim 1, wherein at least one gapping unit is arranged between the first connecting surface of the first net and the second connecting surface of the second net.
